(19) United States
(12) Patent Application Publication
(10) Pub. No.: US 2010/0028477 A1
(43) Pub. Date: Feb. 4, 2010

(54) DENTURE FORMING MACHINE FOR DENTAL USE

(76) Inventors: Hwa Jeong Ryu, Busan (KR); Soo Tae Hwang, Busan (KR)

Correspondence Address: BERLINER & ASSOCIATES, 555 WEST FIFTH STREET, 31ST FLOOR, LOS ANGELES, CA, 90013, US

(21) Appl. No.: 12/374,709

(22) PCT Filed: Jul. 26, 2007
(86) PCT No.: PCT/KR2007/003604

§ 371 Date: May 11, 2009

(30) Foreign Application Priority Data
Jul. 26, 2006 (KR) 10-2006-0070052

(51) Int. Cl. B29C 45/77

(52) U.S. Cl. 425/149

(57) ABSTRACT

A denture forming apparatus for dental use includes clamps for protruding from and retracting to opposing sides in order to clamp or unclamp opposing side portions of the flask, thereby fixing or unfixing the flask; a pressing unit placed above the clamps to charge the resin, contained in a resin-filling pipe, into the flask under a predetermined pressure; and a control unit for controlling the operation of the clamps and controlling the pressing unit to descend at a predetermined rate of descent according to a type of the resin contained in the resin-filling pipe. The denture forming apparatus can be used irrespective of the type of resin since the speed of the pressing unit can be regulated. Accordingly, it is possible to realize an improvement over the conventional art, which can use only a designated type of resin.

### TECHNICAL FIELD

The present invention relates to a denture forming apparatus for dental use, in particular, which can adopt a structure capable of pressing molten resin with a suitable air pressure and a suitable rate of descent to form dentures in a flask, and thus can be widely applied irrespective of resin types as well as rapidly and efficiently form various types of dentures.

### BACKGROUND ART

Typically, to form dentures, powdered resin is melted by heating, and a worker manually charges the molten resin into a denture mold, such as a flask, with a predetermined pressure.

However, it is difficult to steadily apply constant pressure with such a manual operation. Bubbles are not sufficiently exhausted from the heated molten resin, thereby raising the frequency of defects.

In consideration of these problems, there was proposed Korean Utility Model Registration No. 20-233742, entitled “APPARATUS FOR CHARGING AND CURING THERMAL SYNTHETIC RESIN IN MANUFACTURE OF DENTURES” as shown in FIG. 1.

Referring to FIG. 1, the conventional apparatus includes a power switch 18, a central horizontal plate switch 19, a cylinder switch 20, a control panel A consisting of a digital temperature control-display window 21 and a timer 22, injection cylinders 1, a central horizontal plate cylinder 3, resin injection rings 7, a cooling unit 4 and a hot water container 11. The injection cylinders 1 and the central horizontal plate cylinder 3 are fixed to an upper plate 2, and a flask (not shown) is fixed inside the hot water container 11.

In FIG. 1, reference numeral 5 indicates a central horizontal plate, reference numeral 8 indicates a hot water container cover, reference numeral 12 indicates posts, and reference numeral 15 indicates a manometer.

However, most apparatuses according to the conventional art as above can use only a designated type of resin, and thus cannot manufacture dentures by charging or injection molding various types of resin.

In addition, the conventional art has excessively complicated electric lines and too many components, such as cylinders 1 and 3 and a timer 22 for controlling the heating temperature and the running time of the hot water container 11, which have to be controlled. Accordingly, the frequency of the incidence of breakdown of the apparatus naturally rises.

The conventional art uses too many components to realize a desired operation, thereby consuming a large amount of energy due to the operation as well as enlarging the size thereof. Thus, it is difficult to install and move the conventional apparatus.

### DISCLOSURE OF INVENTION

### Technical Problem

The present invention has been made to solve the foregoing problems with the prior art, and therefore, an object of the present invention is to provide a denture forming apparatus for dental use, which can be widely applied irrespective of resin types as well as be used to rapidly and efficiently form various types of dentures.

Another object of the present invention is to provide a denture forming apparatus for dental use, which, even with a small number of components and a small size, can form dentures with a precision as high as can be obtained using expensive large equipment.

A further object of the present invention is to provide a denture forming apparatus for dental use, which does not require that a resin-filling pipe be inserted into the apparatus, thereby improving convenience and minimizing the risk of accidents.

### Technical Solution

According to an aspect of the present invention for realizing the object, the present invention provides a denture forming apparatus for dental use, which charges molten resin into a flask to form dentures. The denture forming apparatus includes clamps that protrude toward and retract from each other in order to clamp or unclamp opposite side portions of the flask, thereby fixing or unfixing the flask; a pressing unit placed above the clamps to charge the resin, contained in a resin-filling pipe, into the flask under a predetermined pressure; and a control unit for controlling the operation of the clamps and controlling the pressing unit to descend at a predetermined rate of descent according to the type of resin contained in the resin-filling pipe.

Preferably, each of the clamps includes a piston rod having a fixing plate at one end thereof, the fixing plate contacting either of the opposing side portions of the flask; and a fixing actuator for linearly reciprocating the piston rod in response to a control signal from the control unit.

Preferably, the fixing actuator comprises one selected from the group consisting of a hydropneumatic cylinder actuator, an electric actuator and a linear motor.

Preferably, the pressing unit includes a pressing rod having an outside diameter corresponding to the inside diameter of the resin-filling pipe, in which a piston is provided at the top end of the pressing rod; and a pressing actuator for reciprocally moving the pressing rod.

Preferably, the pressing actuator includes a cylinder having upper and lower inner spaces, divided by the piston, which performs vertical reciprocal movement in contact with the inner wall surface of the cylinder, and upper and lower inlet holes formed respectively in upper and lower side portions thereof; and an air pressure-regulating unit connected to the upper and lower air inlet holes to supply air to the upper and lower inner spaces of the cylinder, in which the air pressure regulating unit regulates the pressure of the air supplied to the upper and lower air inlet holes in response to a control signal from the control unit.

Preferably, the air pressure-regulating unit includes a filter regulator, including a pressure valve for regulating the pressure of the supplied air, and a filter detachably coupled to the lower part of the pressure valve, the filter removing moisture from the supplied air; an air quantity valve disposed between the filter regulator and the upper and lower air inlet holes via piping, the air quantity valve distributing the air, supplied from the filter regulator, to the air inlet holes by regulating the quantity of the distributed air; and a descent rate valve disposed on a pipe, which connects the air quantity valve to the lower air inlet hole, the descent rate valve regulating the rate of descent of the piston.

Preferably, the control unit includes a power switch for turning on or off externally-supplied power to control the actuation of the clamps; an air quantity switch for controlling the extent of opening or closing of the air quantity valve; and a descent rate switch for controlling the extent of opening or closing of the descent rate valve.

Preferably, the control unit includes a power switch for turning on or off externally-supplied power to control the actuation of the clamps; a selection switch, by which the type of resin is selected; a memory, storing preset extents of opening or closing of the air quantity valve and the descent rate valve, which are predetermined according to the type of resin; and a controller for reading the preset extents from the memory according to the type of resin, which is inputted by the selection switch, to control the extents of opening or closing of the air quantity valve and the descent rate valve.

Preferably, the denture forming apparatus can further include a second pressing unit, placed above the clamps and capable of protruding and retracting, in which the second pressing unit pushes a sealing member to close an inner space of the flask, the sealing member disposed in an upper part of the flask and configured to close a resin passage.

Preferably, the denture forming apparatus can further include a melting unit vertically movably disposed under the pressing unit, the melting unit including a storage unit vertically extending to receive the resin-filling pipe and a heater surrounding the storage unit and generating heat to melt the resin inside the resin-filling pipe; and a transport unit for vertically carrying the melting unit in response to control of the control unit, in which, after the resin is melted in the melting unit, the melting unit is carried down to connect the resin-filled pipe to the fixed flask thereunder.

Preferably, the denture forming apparatus can further include a cover disposed in a front side portion to prevent contact with the melting unit.

### ADVANTAGEOUS EFFECTS

According to the present invention as set forth above, the following effects can be obtained.

First, the apparatus of the present invention can be widely used and improves productivity, so that various types of resin can be used, unlike the conventional art, which allows one apparatus to use only a designated type of resin, and the user can suitably control the pressure and pressing rate necessary for denture forming.

In addition, the present invention can omit unnecessary components and reduce the number of main components, which are electrically controlled, so that the compactness of the apparatus can be realized, the apparatus can be simply operated, and the installation of the apparatus does not require a large space, thereby improving flexibility of space utilization.

Furthermore, the apparatus of the present invention can use any types of flasks that can be fixed to clamps or any types of molds necessary for denture forming in consideration of users of the conventional art, so that the cost of manufacturing new flasks or new molds for various types of dentures can be omitted, thereby providing excellent economic availability.

Moreover, in the apparatus of the present invention, the clamps and the air pressure-regulating units are operated by air, which is supplied through upper and lower air pipes, instead of being operated by hydraulic pressure. This can overcome troubles related to maintenance, such as oil changes and cleaning, as well as reduce the waste of resources, and the apparatus can be operated quickly without any problems.

### BRIEF DESCRIPTION OF THE DRAWINGS

FIG. 1 is a perspective view illustrating the overall structure of a conventional apparatus;

FIG. 2 is a perspective view illustrating the overall exterior structure of a denture forming apparatus for dental use according to the present invention;

FIG. 3 is a conceptual view illustrating an air pipe connection structure in the denture forming apparatus for dental use according to the present invention;

FIG. 4 is a perspective view illustrating a conventional flask pressure-holding unit;

FIG. 5 is a cross sectional view illustrating a flask having a sealing member;

FIG. 6 is a cross sectional view illustrating the flask in which the sealing member closes a passage;

FIG. 7 is a perspective view illustrating the overall exterior of a denture forming apparatus for dental use according to a second embodiment of the present invention;

FIG. 8 is a perspective view illustrating the overall exterior of a denture forming apparatus for dental use according to a third embodiment of the present invention; and

FIG. 9 is a cross sectional view illustrating a melting unit.

### MAJOR REFERENCE NUMERALS OF THE DRAWINGS

100: resin filling pipe 200: clamp
210: air cylinder 220: piston rod
250: melting unit 252: storage unit
254: transport unit 256: guide rod
258: heater 260: safety cover
300: pressing unit 310: pressing rod
320: cylinder 322: upper air inlet hole
324: lower air inlet hole
400: air pressure-regulating unit
410: filter regulator 412: electronic valve
414: filter 420: air quantity valve
430: descent rate valve 500: control unit
510: power switch 530: air quantity switch
540: descent rate switch 600: upper air pipe
700: lower air pipe 800: furnace
900: flask 940: sealing member

### BEST MODE FOR CARRYING OUT THE INVENTION

Hereinafter the present invention will be described more fully with reference to the accompanying drawings, in which exemplary embodiments thereof are shown.

### First Embodiment

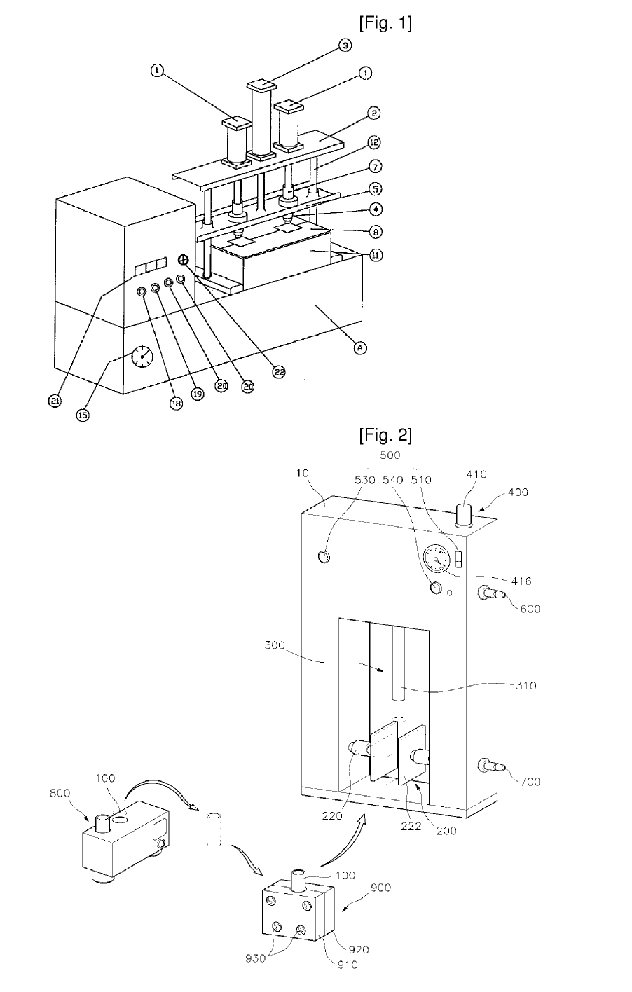

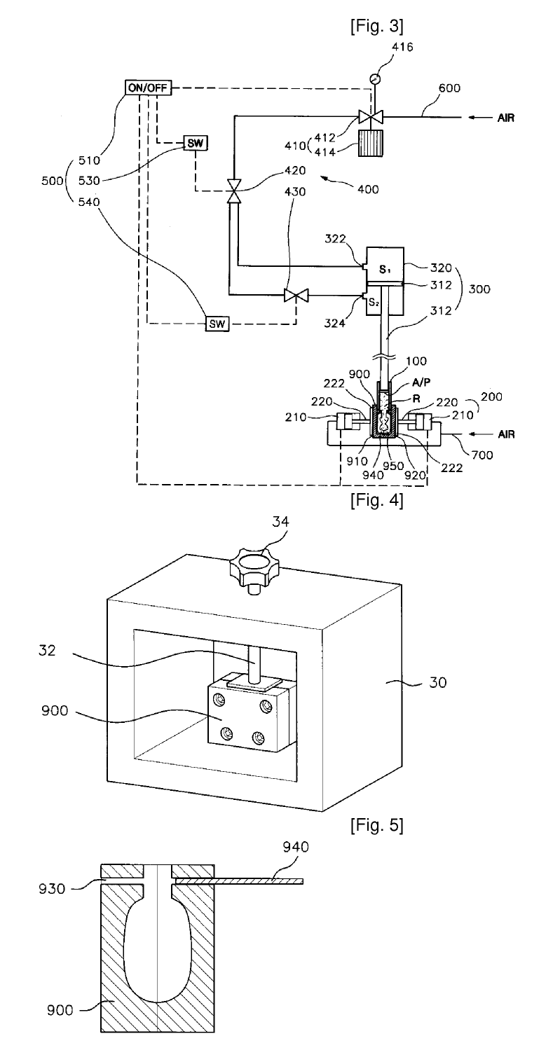

FIG. 2 is a perspective view illustrating the overall exterior structure of a denture forming apparatus for dental use according to the present invention, and FIG. 3 is a conceptual view illustrating an air pipe connection structure in the denture forming apparatus for dental use according to the present invention.

As shown in FIGS. 2 and 3, the denture forming apparatus for dental use of the present invention generally includes clamps 200, a pressing unit 300, an air pressure regulating unit 400 and a control unit 500. These components 200, 300, 400 and 500 are provided inside a housing 10, in which the air pressure-regulating unit 400 is connected to an upper air pipe 600 and the clamps 200 are connected to lower air pipes 700 so that the air pressure-regulating unit 400 and clamps 200 are actuated by the air.

Although the upper and lower air pipes 600 and 700 are illustrated as being disposed on upper and lower parts of the housing 10 to supply the air, this is not intended to limit the present invention. Of course, a modification or an application can be made in such a fashion that a single air pipe is connected to the clamps 200 and the air pressure-regulating unit 400.

In FIG. 2, the reference numeral 416 indicates a manometer, which is connected to a filter regulator of the air pressure regulating unit 400, and the reference numeral 510 indicates a power switch.

An air quantity switch 530 and a descent rate switch 540 are mounted on the front surface of the housing 10. Here, although not shown in the drawings, the air quantity switch 530 is electrically connected to an air quantity valve 420 of the air pressure regulating unit 400, and the descent rate switch 540 is electrically connected to a descent rate valve 430 of the air pressure regulating unit 400. The air quantity valve 420 and the descent rate valve 430 are disposed inside the housing 10, and will be described later.

Here, the clamps 200 and the air pressure-regulating unit 400 are designed to be operated by air instead of hydraulic pressure in order to eliminate problems related with maintenance such as oil changes and cleaning as well as to prevent pollution and the waste of resources owing to unnecessary waste of oil.

In order to form a denture using the denture forming apparatus of the present invention, powdered resin is charged into and melted by heating in a cylindrical resin-filling pipe 100, which is detachably held in a furnace 800. Then, the resin-filling pipe 100 containing the molten resin therein is held in a flask 900, and the molten resin is pressed into a desired shape by the denture forming apparatus of the present invention.

For reference, as shown in the drawings, the flask 900 has a hollow structure, and includes an upper box 910 and a lower box 920, which can be separated from each other and are assembled by fixing members 930. The flask 900 has an inlet (not shown) in the top portion, through which the resin is charged from the resin-filling pipe 100.

Here, as shown in FIG. 3, an upper jaw mold 940 and a lower jaw mold 950 are mounted inside the flask 900, and resin R is filled in the resultant structure.

The reference sign A/P indicates an aluminum plate that is placed on the resin R in order to prevent the end of a pressing rod 310 from being soiled.

Now, respective main components of the denture forming apparatus for dental use of the present invention will be described with reference to FIG. 3.

The clamps 200 of the present invention are components that clamp or unclamp opposing sides of the flask 900 using air pressure, thereby fixing or unfixing the flask 900, and each of the clamps 200 generally includes an air cylinder 210 and a piston rod 220, as shown in FIG. 2.

As shown in FIG. 3, the air cylinder 210 is connected to the lower air pipe 700 provided in the housing 10, as shown in FIG. 10, to receive air from the lower air pipe 700.

The piston rod 220 is mounted inside a respective one of the air cylinders 210, and performs reciprocal motion to protrude from and retract into the cylinder 210 under the control of the control unit 500. Fixing plates 222 in contact with respective sides of the flask 900 are provided on ends of the piston rods 220.

The pressing unit 300 of the present invention is placed above the clamps 200, particularly, above the resin-filling pipe 100, and acts to charge the resin contained in the resin-filling pipe 100 into the flask 900 under a predetermined pressure while it descends.

Here, the pressing unit 300 generally includes a pressing rod 310 and a cylinder 320. A piston 312, which is provided at the top end of the pressing rod 310, is in the shape of a rod that has an outside diameter corresponding to the inside diameter of the resin-filling pipe 100.

The piston 312 contacts the inner surface of the cylinder 320 while it reciprocates upward and downward. The inside of the cylinder 320 is divided into upper and lower spaces S1 and S2 by the piston 312, and upper and lower air inlet holes 322 and 324 are formed, respectively, in upper and lower sides of the cylinder 320.

The pressing rod 310 performs the reciprocal motion according to the quantities of air that are supplied into the upper and lower spaces S1 and S2 through the upper and lower air inlet holes 322 and 324.

That is, the pressing rod 310 descends if the quantity of air supplied into the upper space S1 is larger than that supplied into the lower space S2, and rises if the quantity of air supplied into the upper space S1 is smaller than that supplied into the lower space S2.

The air pressure regulating unit 400 of the present invention is connected to the pressing unit 300 via piping, and acts to supply air to the pressing unit 300, thereby regulating the pressure thereof. The air pressure regulating unit 400 generally includes a filter regulator 410, an air quantity valve 420 and a descent rate valve 430.

The filter regulator 410 generally includes an electronic valve 412 and a filter 414, in which the electronic valve 412 is connected to the upper air pipe 600 to regulate the pressure of air supplied from the upper air pipe 600. Preferably, the manometer 416 is further mounted on the housing (10, see FIG. 2) to identify the pressure.

The electronic valve 412 is a known device such as a solenoid valve that opens or closes a channel according to current. Although the electronic valve is adopted in the present invention, a manual system, in which the user opens or closes the channel himself or herself, can also be used.

The filter 414 is detachably coupled to the lower part of the electronic valve 412, and acts to separate moisture from the supplied air so that only clean air can be supplied.

The air quantity valve 420 is interposed between and connected via piping to the filter regulator 410 and the upper and lower air inlet holes 322 and 324, and acts to distribute the air supplied from the filter regulator 410 to the air inlet holes 322 and 324 by regulating the quantity of the supplied air.

The air quantity valve 420 acts to open or close the channel according to current, like the electronic valve 412 of the filter regulator 410. The air quantity valve 420 is a three way valve, due to which a single flow of air supplied from the upper air pipe 600 diverges into two flows toward the upper and lower air inlet holes 322 and 324 of the cylinder 320 of the pressing unit 300.

The descent rate valve 430 is mounted on a pipe that connects the air quantity valve 420 to the lower air inlet hole 324, and acts to regulate the rate of descent of the piston 312 of the pressing unit 300.

When the pressing rod 310 is about to rapidly descend as the air drastically flows into the upper space S1 through the upper air inlet hole 322, the descent rate valve 430 opens the pipe connected to the lower air inlet hole 322 to supply air into the lower space S, thereby obtaining a damping effect.

The control unit 500 of the present invention is electrically connected to the clamps 200 and the air pressure regulating unit 400, and acts to control the operation of the clamps 200, the rate of rise or descent of the pressing unit 300 and the air pressure of the air pressure regulating unit 400.

The control unit 500 of the present invention generally includes the power switch 510, the air quantity switch 530 and the descent rate switch 540.

The power switch 510 supplies power to the switches 530 and 540 by turning on or off the power that is externally supplied, and acts to fix opposing sides of the flask 900 to the clamps 200 by turning on the power and to release the opposing sides of the flask 900 by turning off the power.

The air quantity switch 530 is electrically connected to the air quantity valve 420 to control the extent of opening or closing of the air quantity valve 420.

That is, the air quantity switch 530 varies the extent of opening or closing of the pipes leading to the upper and lower air inlet pipes 322 and 324 in order to regulate the amounts of air supplied to the upper and lower spaces S1 and S2 of the cylinder 320 of the pressing unit 300 as described above, thereby raising the pressing rod 310 due to the difference in volumes of the upper and lower spaces S1 and S2.

The descent rate switch 540 is electrically connected to the descent rate valve 430 to control the extent of opening or closing of the descent rate valve 430.

That is, when the pressing rod 310 is about to rapidly descend as air rapidly flows (or as a large amount of air flows) into the upper space S1 through the upper air inlet hole 322, the descent rate switch 540 suitably varies the extent of opening of the pipe leading to the lower air inlet hole 324 in order to supply the air into the lower space S, thereby obtaining a damping effect.

Of course, in addition to the damping effect described above, the descent rate switch 540 can be applied in a different fashion. That is, the descent rate switch 540 can also act to reduce the extent of opening of the descent rate valve 430 but relatively enlarges the extent of opening of the channel toward the upper air inlet hole 322 using the air quantity switch 530, thereby enhancing the rate of descent of the pressing rod 310.

Owing to the respective switches 530 and 540, operating as described above, it is possible to positively obtain various pressures and rates of descent that are necessary to shape resins available from various manufacturers.

Now, the operation of the denture forming apparatus for dental use of the present invention as configured above will be described with reference to FIGS. 2 and 3.

First, powdered resin (not shown) is charged into the resin-filling pipe 100, which is inserted into the furnace 800. In order to prevent the resin from leaking, a thin member such as a piece of silver paper or foil (hereinafter referred to as “silver foil”) is wrapped on the bottom end of the resin-filling pipe 100 before the resin is charged.

Then, the furnace 800 is powered on to melt the resin in the resin-filling pipe 100. The resin-filling pipe 100 containing the molten resin therein is then held in the upper part of the flask 900. After the flask 900 is placed between the clamps 200, the power switch 510 is turned on.

It is preferable that the user align the resin-filling pipe 100, held in the upper part of the flask 900, with the end of the pressing rod 310 of the pressing unit 300.

Then, the user actuates an air compressor (not shown) in order to supply air through the upper and lower air pipes 600 and 700, which are connected, respectively, to the air pressure regulating unit 400 and the clamps 200.

Subsequently, the fixing plates 222 of the clamps 200 are fixed so that the air introduced through the lower air pipe 700 causes the fixing plates 222 to play and contact opposing sides of the flask 900.

Here, the user checks whether or not a suitable amount of pressure is maintained using the manometer 416 connected to the filter regulator 410, and adjusts the extent of opening or closing of the air quantity valve 420 and the descent rate valve 430 connected to the switches 530 and 540, using the air quantity switch 530 and the descent rate switch 540, so that the pressing rod 310 of the pressing unit 300 descends.

Then, the pressing rod 310 descends at a predetermined rate and charges the resin (R, see FIG. 3) contained in the resin-filling pipe 100 into the space between the upper and lower jaw molds 940 and 950 of the flask 900, thereby forming dentures.

Here, the resin R tears the silver foil wrapped on the bottom end of the resin-filling pipe 100.

Finally, the upper and lower jaw molds 910 and 920, which are coupled with each other by the fixing members 930, are separated from each other to remove the finally shaped resin R from between the upper and lower jaw molds 940 and 950, thereby obtaining the dentures according to the present invention.

### Second Embodiment

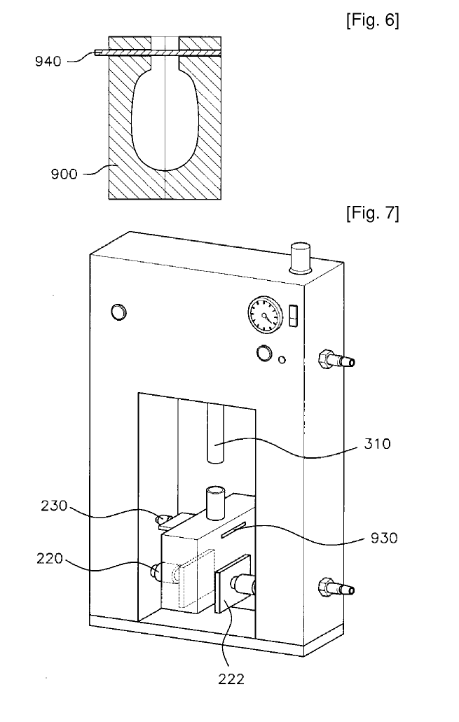

FIG. 4 is a perspective view illustrating a conventional flask pressure-holding unit, FIG. 5 is a cross sectional view illustrating a flask having a sealing member, and FIG. 6 is a cross sectional view illustrating the flask in which the sealing member closes a passage.

According to the first embodiment, the pressing rod 310 presses the resin charged in the resin-filling pipe 100, thereby pushing the resin downward into the flask 900. If the pressing rod 310 and the resin-filling pipe 100 are separated from the flask in the state in which the resin is charged into the flask, a portion of the resin, which is under high pressure, leaks through the open upper part of the flask, thereby degrading the quality of the resultant dentures.

If the resin is cured with the pressing rod 310 coupled with the resin-filling pipe 100, the internal pressure of the flask is maintained, and thus uniform quality can be obtained. However, in the case of consecutively forming a plurality of dentures, it is required that the flasks in the denture forming apparatus be replaced. Accordingly, it is impossible to keep the flask in the denture forming apparatus for a long time.

Furthermore, according to the type of resin, it is necessary to separate the flask from the denture forming apparatus in order to rapidly cool the shaped resin by submerging it into cooling water. However, in this case, it is difficult to maintain the internal pressure of the flask.

The pressure-holding unit 30 as shown in FIG. 4 was developed in order to overcome this problem. According to this pressure-holding unit 30, a flask 900 is separated from the denture forming apparatus and is placed in the pressure-holding unit 30, and then a knob 34 is turned to close the upper part of the flask 900 with a rod 32, which has threads and a plate attached to the bottom thereof. Therefore, the internal pressure cannot be maintained in the flask that is separated from the denture forming apparatus.

In order to overcome this problem, the flask 900 as shown in FIGS. 5 and 6 is devised. The flask 900 has a hole 930 formed in the top portion thereof, crossing a resin passage, and a plate-shaped sealing member 940 capable of closing the hole 930. After resin is loaded, the sealing member 940 is pushed into the hole 930 to close the resin passage.

As shown in FIG. 7, the second embodiment of the present invention includes a second pressing unit 230 above clamps 220 in order to push the sealing member to close the resin passage. The second pressing unit 230 pushes the sealing member 940 while reciprocally moving under the pressure of air, like the clamps. The second pressing unit 230 is provided at one side, unlike the clamps, since it merely pushes the sealing member in one direction.

When the pressing unit descends and resin is charged into the flask, the control unit supplies air to the second pressing unit 230 so that the second pressing unit 230 moves forward to push the sealing member, thereby closing the passage of the flask.

When the sealing member 940 closes the passage of the flask as shown in FIG. 6, the flask 900 is separated from the denture forming apparatus to cure the resin at room temperature. Alternatively, the separated flask 900 is submerged into cooling water to rapidly cool the resin.

### Third Embodiment

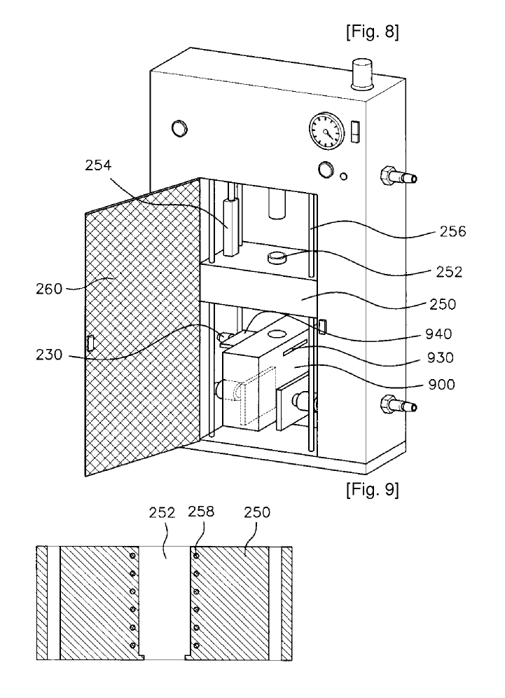

FIG. 8 is a perspective view illustrating the overall exterior of a denture forming apparatus for dental use according to a third embodiment of the present invention, and FIG. 9 is a cross sectional view illustrating a melting unit.

According to the third embodiment, the melting unit 250 is attached to the bottom portion of the pressing unit, as shown in FIG. 8. The melting unit 250 is provided to allow the filling and the melting of resin to be performed sequentially and thus make it unnecessary to move the resin-filling pipe. Otherwise, if the resin is melted in a separate furnace, the resin can be cooled down while it is moved from the furnace to the flask. Moving the heated resin-filling pipe may cause a burn, or the resin may pour from the heated resin-filling pipe during the movement.

In the third embodiment, a safety cover 260 is provided in the front side. Since the melting unit is hot when operating, the safety cover 260 can protect the user from a burn.

The safety cover 260 is hinged at one edge thereof so that it can be opened or closed. The safety cover 260 is closed during operation in order to prevent an accident.

The safety cover 260 can be made of a transparent material or mesh so that the user can observe the inside.

As shown in FIG. 9, the melting unit includes a hollow storage unit 252, which vertically extends to receive the resin-filling pipe, and a heater 258, which surrounds the storage unit 252 and generates heat to melt the resin inside the resin-filling pipe. In the third embodiment, the heater is implemented with a hot wire that is coiled around the storage unit.

A transport unit 254 for vertically carrying the melting unit is also provided. In the third embodiment of the present invention, the transport unit 254 includes two cylinders, which are placed on the top of the melting unit to vertically move under air pressure. In place of the movement under air pressure, it is also possible to use gears to carry the transport unit through the rotation thereof, or to use a linear motor, a chain or the like.

Vertical through holes are formed in the melting unit and guide rods 256 are inserted into the through holes so that the melting unit can vertically move along the guide rods 256. This can prevent the melting unit from shaking when it is vertically carried.

The reason for providing the transport unit that vertically carries the melting unit is as follows: Since the melting unit interferes with the flask when the flask is inserted into the apparatus, the transport unit can raise the melting unit in order to easily place the flask inside the apparatus.

The transport unit that vertically carries the melting unit is provided to facilitate the insertion of the flask into the apparatus. That is, since the melting unit interferes with the flask when the flask is inserted into the apparatus, the transport unit raises the melting unit so that the flask can be easily placed inside the apparatus.

The transport unit is also devised to prevent the apparatus from being damaged by the heat for melting the resin. That is, if the melting unit 250 is placed in the upper or lower part, heat can be transmitted through metal members having high thermal conductivity, such as the pressing rod 310, the flask 900 and the clamps 220, thereby damaging various devices inside the apparatus.

Accordingly, the melting unit is separated from the pressing unit, which is positioned above the melting unit, or the clamps or the flask, which is positioned below the melting unit, while the resin is heated and melted. Just before the completely melted resin is charged, the melting unit is moved down and coupled with the flask, and then the resin is charged using the pressing unit.

As set forth above, the technical concept of the present invention is to provide a denture forming apparatus for dental use that can be widely applied irrespective of resin types and can be used to rapidly and efficiently form various types of dentures. Even if the denture forming apparatus of the present invention has a small number of components and a small size, the denture forming apparatus of the present invention can form dentures with a precision as high as can be obtained using expensive and large equipment.

It is to be appreciated that those skilled in the art can substitute, change or modify the embodiments in various forms without departing from the scope and spirit of the present invention. For example, in place of the air cylinder described in the foregoing embodiments, various devices, such as a linear motor that can undergo linear reciprocal motion, can also be used.

1. A denture forming apparatus for dental use, which charges molten resin into a flask to form dentures, comprising:
clamps for protruding toward and retracting from each other in order to clamp or unclamp opposing side portions of the flask, thereby fixing or unfixing the flask; a pressing unit placed above the clamps to charge the resin, contained in a resin-filling pipe, into the flask under a predetermined pressure; and
a control unit for controlling operation of the clamps and controlling the pressing unit to descend at a predetermined rate of descent according to a type of the resin contained in the resin-filling pipe.

2. The denture forming apparatus according to claim 1, wherein each of the clamps includes:
a piston rod having a fixing plate at one end thereof, the fixing plate contacting either one of the opposing side portions of the flask; and
a fixing actuator for linearly reciprocating the piston rod in response to a control signal from the control unit.

3. The denture forming apparatus according to claim 2, wherein the fixing actuator comprises one selected from a group consisting of a hydropneumatic cylinder actuator, an electric actuator and a linear motor.

4. The denture forming apparatus according to claim 1, wherein the pressing unit includes:
a pressing rod having an outside diameter corresponding to an inside diameter of the resin-filling pipe, wherein a piston is provided at a top end of the pressing rod; and
a pressing actuator for reciprocally moving the pressing rod.

5. The denture forming apparatus according to claim 4, wherein the pressing actuator includes:
a cylinder having upper and lower inner spaces, divided by the piston that performs vertical reciprocal movement in contact with an inner wall surface of the cylinder, and upper and lower inlet holes formed respectively in upper and lower side portions thereof; and
an air pressure-regulating unit connected to the upper and lower air inlet holes to supply air to the upper and lower inner spaces in the cylinder, wherein the air pressure regulating unit regulates a pressure of the air supplied to the upper and lower air inlet holes in response to a control signal from the control unit.

6. The denture forming apparatus according to claim 5, wherein the air pressure-regulating unit includes:
a filter regulator including a pressure valve for regulating the pressure of the supplied air and a filter detachably coupled to a lower part of the pressure valve, the filter separating moisture of the supplied air; an air quantity valve disposed between the filter regulator and the upper and lower air inlet holes via piping, the air quantity valve distributing the air, supplied from the filter regulator to the air inlet holes by regulating a quantity of the distributed air; and
a descent rate valve disposed on a pipe, which connects the air quantity valve to the lower air inlet hole, the descent rate valve regulating a rate of descent of the piston.

7. The denture forming apparatus according to claim 6, wherein the control unit includes:
a power switch for turning on or off an externally-supplied power to control actuation of the clamps; an air quantity switch for controlling an extent of opening or closing of the air quantity valve; and
a descent rate switch for controlling an extent of opening or closing of the descent rate valve.

8. The denture forming apparatus according to claim 6, wherein the control unit includes:
a power switch for turning on or off an externally-supplied power to control actuation of the clamps;
a selection switch, by which the type of the resin is selected;
a memory storing preset extents of opening or closing the air quantity valve and the descent rate valve, which are predetermined according to the type of the resin; and
a controller for reading the preset extents from the memory according to the type of the resin, which is inputted by the selection switch, to control the extents of opening or closing the air quantity valve and the descent rate valve.

9. The denture forming apparatus according to claim 1, further comprising a second pressing unit placed above the clamps and capable of protruding and retracting, wherein the second pressing unit pushes a sealing member to close an inner space of the flask, the sealing member disposed in an upper part of the flask and configured to close a resin passage.

10. The denture forming apparatus according to claim 1, further comprising:
a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and
a transport unit for vertically carrying the melting unit in response to control of the control unit, wherein, after the resin is melted in the melting unit, the melting unit is carried down to connect the resin-filling pipe to the fixed flask thereunder.

11. The denture forming apparatus according to claim 10, further comprising a cover disposed in a front side portion to prevent contact with the melting unit.

12. The denture forming apparatus according to claim 2, further comprising: a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and a transport unit for vertically carrying the melting unit in response to control of the control unit, wherein, after the resin is melted in the melting unit, the melting unit is carried down to connect the resin-filling pipe to the fixed flask thereunder.

13. The denture forming apparatus according to claim 3, further comprising:
a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and
a transport unit for vertically carrying the melting unit in response to control of the control unit, wherein, after the resin is melted in the melting unit, the melting unit is carried down to connect the resin-filling pipe to the fixed flask thereunder.

14. The denture forming apparatus according to claim 4, further comprising:
a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and
a transport unit for vertically carrying the melting unit in response to control of the control unit, wherein, after the resin is melted in the melting unit, the melting unit is carried down to connect the resin-filling pipe to the fixed flask thereunder.

15. The denture forming apparatus according to claim 5, further comprising:
a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and
a transport unit for vertically carrying the melting unit in response to control of the control unit, wherein, after the resin is melted in the melting unit, the melting unit is carried down to connect the resin-filling pipe to the fixed flask thereunder.

16. The denture forming apparatus according to claim 6, further comprising:
a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and
a transport unit for vertically carrying the melting unit in response to control of the control unit, wherein, after the resin is melted in the melting unit, the melting unit is carried down to connect the resin-filling pipe to the fixed flask thereunder.

17. The denture forming apparatus according to claim 7, further comprising:
a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and
a transport unit for vertically carrying the melting unit in response to control of the control unit, wherein, after the resin is melted in the melting unit, the melting unit is carried down to connect the resin-filling pipe to the fixed flask thereunder.

18. The denture forming apparatus according to claim 8, further comprising:
a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and
a transport unit for vertically carrying the melting unit in response to control of the control unit, wherein, after the resin is melted in the melting unit, the melting unit is carried down to connect the resin-filling pipe to the fixed flask thereunder.

19. The denture forming apparatus according to claim 9, further comprising:
a melting unit vertically movably disposed under the pressing unit, wherein the melting unit includes a storage unit vertically extending to receive the resin-filling pipe and a heater surrounding the storage unit and generating heat to melt the resin inside the resin-filling pipe; and
a transport unit for vertically carrying the melting unit in response to control of the control unit, wherein, after the resin is melted in the melting unit, the melting unit is carried down to connect the resin-filling pipe to the fixed flask thereunder.
